(19) United States
(12) Patent Application Publication
(10) Pub. No.: US 2017/0345292 A1
(43) Pub. Date: Nov. 30, 2017

(54) WIRELESS PEDESTRIAN NOTIFICATION

(71) Applicant: AUTOTALKS LTD., Kfar Netter (IL)

(72) Inventor: ONN HARAN, Bnei Dror (IL)

(21) Appl. No.: 15/426,063

(22) Filed: Feb. 7, 2017

Related U.S. Application Data
(60) Provisional application No. 62/343,012, filed on May 30, 2016.

(51) Int. Cl. G08G 1/005; G05D 1/00; G02B 27/01; G08G 1/16

(52) U.S. Cl. CPC G08G 1/005; G08G 1/166; G05D 1/0088; G02B 27/0172; G02B 2027/0141; G02B 2027/0178

(57) ABSTRACT

Method for wireless communication in an environment that includes autonomous vehicles, comprising: by a given autonomous vehicle, transmitting a dedicated notification message to a personal unit of a particular pedestrian, wherein the personal unit is configured to alert the particular pedestrian about contents of the dedicated notification message.

### CROSS REFERENCE TO RELATED APPLICATIONS

This application is related to and claims priority from U.S. Provisional Patent Application 62/343,012 having the same title and filed May 30, 2016, which is incorporated herein by reference in its entirety.

### FIELD

Embodiments disclosed herein relate generally to vehicle-to-everything (V2X) communications and in particular to vehicle-to-pedestrian (V2P) communications in which pedestrians (P) interact with autonomous vehicles (V).

### BACKGROUND

In known art, autonomous vehicles lack the ability of interaction with pedestrians. While humans can communicate with gestures, robots do not. The interaction between autonomous vehicles and pedestrians has been studied, for example in U.S. Pat. No. 9,196,164 and some publications. The studies commonly address visual or audible notifications, but do not address targeted (or “dedicated”) wireless notifications from a vehicle to a relevant pedestrian. Visual notifications are expensive, have non-appealing appearance and cannot distinguish between information relevant to different pedestrians. Specifically as disclosed in U.S. Pat. No. 9,196,164, a pedestrian may receive communications from autonomous vehicles, but he/she does not know if a particular vehicle saw him/her and does not know if the vehicle is about to give way.

Methods of V2P wireless communication are known, see e.g. U.S. Pat. No. 8,253,589. Such methods include defining a data container broadcasted periodically by the pedestrian, but do not define a handshake between vehicle and pedestrian.

An example of a notification environment in which notifications may be exchanged between autonomous vehicles and pedestrians is illustrated in FIG. 1. An autonomous vehicle 102 is shown driving North on road 104. On the right side, a pedestrian 106 is shown crossing the street also in the North direction, while ahead a pedestrian 108 is shown planning to cross the street in the East direction. In an exemplary scenario, the pedestrians would like to know that a specific autonomous vehicle, which does not have a driver who can initiate eye contact, is about to yield (give way) to them. In known art, the two pedestrians have no way of knowing that vehicle 104 sees them, and if yes, if it will yield to them or not.

An embodiment of a known art V2P wireless communication environment is illustrated in FIG. 2. A pedestrian unit (“PU”) 200 that includes a radio module 202, a processing module 204 and a display 206 is in communication with, and collects notifications from a plurality of vehicles 210, 212, 214 and 216 that send broadcast notification messages toward PU 200. As used herein, “pedestrian unit” is a term that covers all wireless communication devices that can transmit pedestrian location and can display alerts. A PU may be for example a personal electronic device (PED), “smart glasses” such as Google Glass™, or another augmented reality device (ARD). The PED may for example be a smartphone capable of presenting significant amount of data on a large display. Alternatively, the PED may be a wearable electronic device. An ARD may also be capable of marking visually attributes relayed by a respective vehicle on the respective vehicle.

V2X communications in general and V2P communications in particular rely on broadcast transmission without any feedback. The wireless link is not symmetric. The fact that a pedestrian has received a message from a vehicle does not mean that the vehicle has received a message from the pedestrian. In other words, V2P communications in known art are “open loop”, in particular in the sense that autonomous vehicles cannot indicate pedestrian recognition, warnings, vehicle intentions, etc., using eye contact or gestures.

### SUMMARY

In view of the known art in which V2P communications are open loop, a “dedicated” notification from an autonomous vehicle to a pedestrian is needed to close the loop. Such a notification may provide to the pedestrian various indications, for example that crossing of a street in front of a particular approaching autonomous vehicle is safe, that a particular vehicle yields, etc. In some embodiments, the dedicated notification may be transmitted using a dedicated notification message. In some embodiments, the dedicated notification may be transmitted using one or more “dedicated attributes” i.e. attributes attached to, or included in a periodic vehicle safety message broadcast by the autonomous vehicle.

In exemplary embodiments, there is provided a method for notifying a pedestrian (or a manned vehicle) through wireless communication that an autonomous vehicle is aware of his/her presence and that it will take a certain action. The pedestrian and/or the manned vehicle are individually identifiable by a respective target address. The method performs a handshake and closes a loop in V2P communications. As used hereinafter, the term “handshake” refers to actions undertaken between an autonomous vehicle and a pedestrian that include broadcast by the pedestrian and transmission of a dedicated message from the vehicle to the pedestrian. When the following description refers to “vehicle”, the reference is to an autonomous vehicle. For simplicity, the description continues with reference only to “pedestrian” with the understanding that actions pertaining to a pedestrian apply equally to a driver of a manned vehicle. The certain action may be for example either “yield” (to the pedestrian) or “not yield” to the pedestrian. The dedicated notification message includes at least two attributes: “I see you” and “I yield to you”. The particular terms or phrases used herein are for example only, and the two attributes may be phrased in a different way while keeping their essential intent. In addition, the dedicated notification message may include an alert attribute such as “watch out”, warning the pedestrian about other vehicles that may endanger him/her. Hereinafter, the term “notification” may be used for simplicity instead of “dedicated notification message”. The notification may displayed on a human-machine interface (HMI) of the PU, or relayed to the PU in another way (e.g. by vibrations).

As a result of a dedicated notification, a pedestrian (or a manned vehicle) receiving it may take appropriate action. For example, after receiving a notification with the attribute “I yield to you”, a pedestrian may proceed to cross a street. For example, after receiving a notification “not yield”, a pedestrian may wait till the transmitting given vehicle passes him, before crossing the street. For example, after receiving a notification “watch out”, a pedestrian may scan the environment for potential danger.

In some exemplary embodiments, there is provided a method for wireless communication in an environment that includes autonomous vehicles, comprising: by a given autonomous vehicle, transmitting a dedicated notification message to a personal unit (PU) of a particular pedestrian, wherein the PU is configured to alert the particular pedestrian about contents of the dedicated notification message.

In an embodiment, the PU is configured to alert the particular pedestrian by displaying at least part of the dedicated notification message on a HMI of the PU. In an embodiment, the HMI includes a radar-like display of a smartphone.

In an embodiment, the PU includes a personal electronic device. In an embodiment, the PU includes an augmented reality device. In an embodiment, the augmented reality device includes smart glasses.

In an embodiment, the transmitting a dedicated notification message to a PU of a particular pedestrian includes transmitting a dedicated notification device having at least one attribute. In an embodiment, the at least one attribute includes an attribute by which the autonomous vehicle indicates an action intended by the autonomous vehicle. In an embodiment, the action intended includes an action to yield to the particular pedestrian. In an embodiment, the at least one attribute includes an attribute by which the autonomous vehicle indicates its relative positioning to the particular pedestrian. In an embodiment, the at least one attribute includes an attribute by which the autonomous vehicle warns the particular pedestrian about other vehicles.

In an embodiment, the PU is further configured to have an open receive window for receiving the dedicated notification message in a fixed time slot to save power.

In some exemplary embodiments, there is provided a method for wireless communication in an environment that includes autonomous vehicles, comprising: by a given autonomous vehicle, broadcasting a periodic notification message having at least one dedicated attribute addressed to a personal unit of a particular pedestrian or of a particular driver of a manned vehicle, wherein the personal unit is configured to alert the particular pedestrian or particular driver about the at least one dedicated attribute.

In an embodiment, the at least one dedicated attribute includes an attribute by which the autonomous vehicle indicates an action intended by the autonomous vehicle.

In an embodiment, the action intended includes an action to yield to the particular pedestrian or particular driver.

The pedestrian unit may have low computational capacity and is likely to employ a strict power-saving policy that limits its availability. Therefore, the V2P notifications are sent based on vehicle's decisions. The vehicle predicts if the notification has value to a pedestrian (see e.g. FIG. 3 and its description) and which pedestrians should be notified. The pedestrian may aggregate the notifications and may display them on the HMI, either as a radar-display on a PED or as a digital marking in an augmented reality device, like Google glasses or similar.

A handshake method suggested here can be extended to any vulnerable road user, such as bicyclist or a motorcyclist, as well as to (as mentioned) human drivers entering an intersection and wishing to know that they may drive ahead without colliding with the autonomous vehicle.

### BRIEF DESCRIPTION OF THE DRAWINGS

Aspects, embodiments and features disclosed herein will become apparent from the following detailed description when considered in conjunction with the accompanying drawings.

FIG. 1 illustrates an example of an environment in which notifications may be exchanged between autonomous vehicles and pedestrians;

FIG. 2 illustrates schematically an embodiment of a known art V2P wireless communication environment;

FIG. 3 shows in a flow chart an embodiment of a method for dedicated notification of a pedestrian by a vehicle disclosed herein;

FIG. 4 shows an exemplary embodiment of the content of a dedicated notification message;

FIG. 5 illustrates a radar-like pedestrian unit HMI;

FIG. 6 illustrates schematically a smart glasses type pedestrian unit HMI.

FIG. 7 illustrates a scheme for low-power pedestrian unit operation;

FIG. 8 illustrates an example of an environment in which notifications may be exchanged between autonomous vehicles and/or between autonomous and manned vehicles.

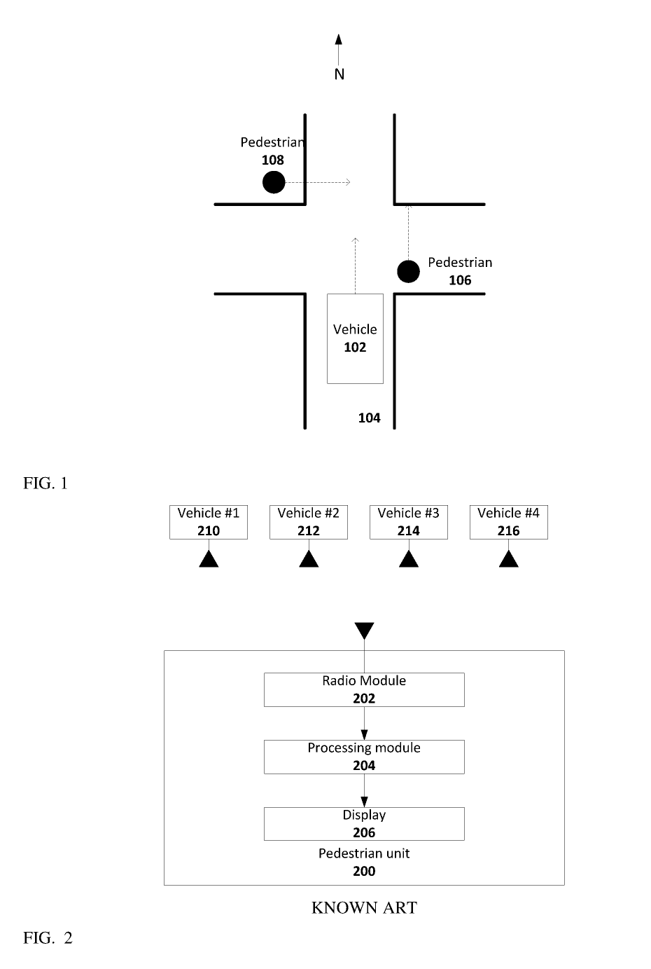

### DETAILED DESCRIPTION

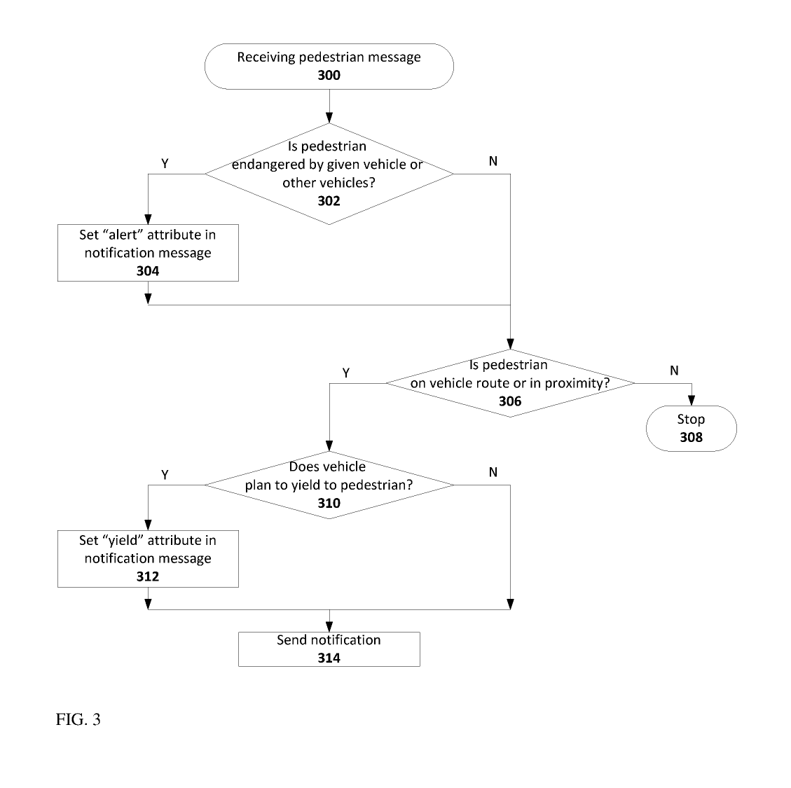

FIG. 3 shows in a flow chart an embodiment of a method for dedicated notification of a pedestrian by a vehicle disclosed herein. The entire operation is performed at a given autonomous vehicle, for example vehicle 210 of FIG. 2. A PU (such as PU 200) transmits messages periodically (e.g. once a second) to its surroundings. The operation begins in step 300, when the given vehicle receives one of those periodic messages from a particular pedestrian. In step 302, the given vehicle performs a check, based on known V2V predictions (for example as taught in U.S. Pat. No. 8,253,589). The check checks if the given vehicle or other vehicles in its proximity endanger the particular pedestrian. If Yes in check step 302, an attribute of “alert” is set in a notification message in step 312. If the particular pedestrian is not endangered (No in check step 302), operation continues from step 306, in which a check is performed by the autonomous vehicle to check whether the particular pedestrian in on the given vehicle's route or in its proximity. Note that an autonomous vehicle's route is known exactly, while the pedestrian's route is predicted. Thus, the two routes can be matched for proximity. If No in step 306 (i.e. if the pedestrian is not in vehicle's route or its proximity), operation stops in step-308. Otherwise (Yes in step 306), operation continues in step 310, in which a check is performed by the given vehicle to determine if the vehicle plans to yield to the pedestrian. That is, the autonomous vehicle has a driving policy algorithm that determines if the vehicle is about to yield. If Yes in check step 310, (i.e. the vehicle behavior is currently affected by the pedestrian, meaning e.g. that the vehicle is slowing down to yield), then an attribute is set in a notification message in step 312, and the notification message is transmitted to the pedestrian in step 314. If No in check step 310, a notification message is sent to the pedestrian without this attribute.

Optionally, after receiving a notification with at least one attribute (either in a dedicated notification message or as a dedicated attribute in a periodic broadcast message), a pedestrian and/or the driver of a manned vehicle may undertake appropriate action, for example to wait for the given autonomous vehicle to pass, to cross a street or intersection, to turn into a street, etc.

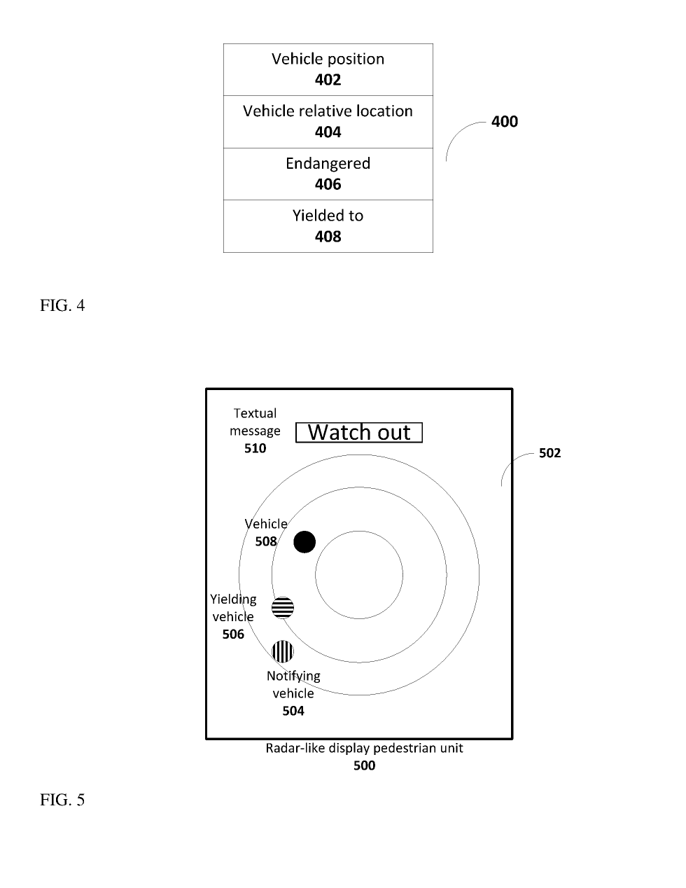

FIG. 4 shows an exemplary embodiment of the content of a dedicated notification message 400. Sending a notification disclosed herein in a dedicated message is preferred for power saving by the PU. Note that the same data elements (content) may be attached to the periodic vehicle safety message transmitted from the autonomous vehicle to a pedestrian or another vehicle, to reduce the amount of transmitted data. However, while the periodic vehicle safety messages are broadcast, a dedicated notification message is sent only to a particular pedestrian. While the periodic vehicle safety message itself is broadcast, dedicated attributes included in it are addressed only to the PU of a particular pedestrian (or to the driver of a manned vehicle). This is achieved by adding the address of the target PU to the broadcast message. Other personal units are expected to ignore this information.

Returning to FIG. 4, a vehicle position 402 is provided to pedestrian units that can use it. A relative vehicle location (relative to the pedestrian's location) field 404 is provided (for example as radius and angle) to ease processing by the PU. A “warning” alert field 406 indicates if the particular pedestrian is under some kind of danger. The PU receives the alert and exhibits it to the particular pedestrian. The particular pedestrian thus knows that the given vehicle saw him/her. Field 406 may also include supporting data, like “stop”, “watch out”, “look left”, “look right”, “look ahead”, etc. A “yielded to” field 408 indicates to the pedestrian that the vehicle slows down, or is about to slow down, or stops for the pedestrian. Note that in other notification message embodiments, the content may include different fields in different order.

To clarify, a dedicated notification message disclosed herein may include less or more than the four fields/data elements/attributes shown in FIG. 4. For example, in an embodiment, a dedicated notification message may include a single field with an exemplary attribute “I yield”. For example, in an embodiment, a dedicated notification message may include two fields, with exemplary attributes “I see you” and “I yield”. For example, in an embodiment, a dedicated notification message may include three fields, with exemplary attributes “I see you”, “look left” and “I do not yield”.

The HMI of a smartphone device can be used to display a radar-type display, see FIG. 5. A pedestrian unit 500 shows vehicles on a radar-type display 502, where the radar North direction is adjusted to the device heading. On the radar-type display, vehicles that notify may be marked as icons (or realistic images) colored with an “assuring” color such as green, or by another similar assuring color. If the vehicle yields, the icon (or realistic image) or color may change. For the sake of a non-color drawing example as shown herein, using only black and white lines, a notifying vehicle 504 is marked with vertical lines, a notifying vehicle 506 that is about to yield is marked with horizontal lines, and a vehicle 508 that did not notify is marked with solid lines. Danger (to the pedestrian) may be marked based on the location of an endangering vehicle, or as guidance (for example by a text notification, displayed close to a specific vehicle or somewhere else). That is, the endangering vehicle can be marked by, for example, another color. Alternatively or in addition, text 510 (e.g. “watch out”) can be displayed as a warning without specific identification of the danger location. A danger alert may also involve phone vibration or ringing.

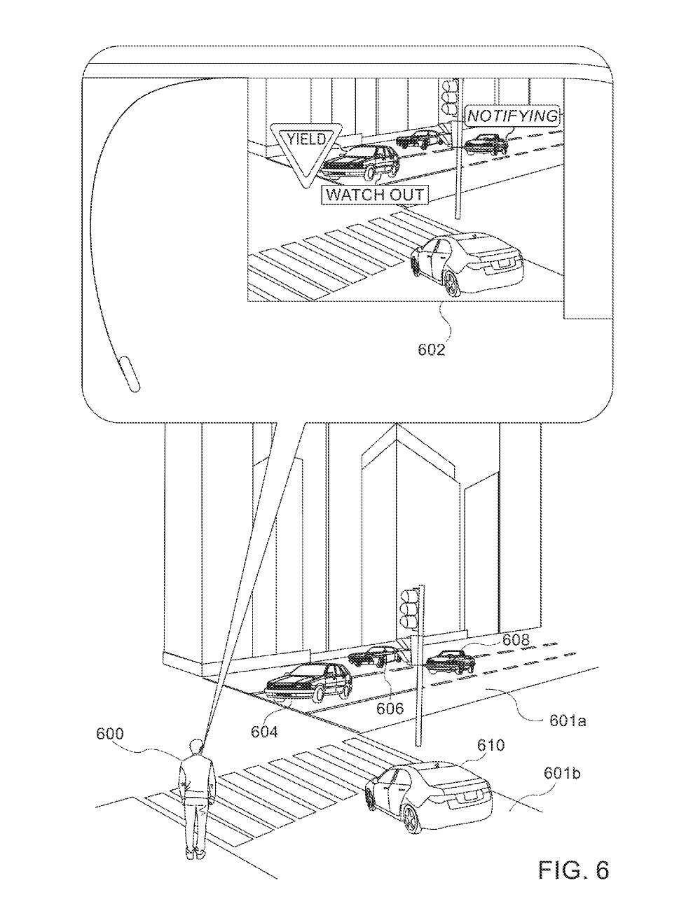

In an embodiment, the pedestrian can identify which vehicle sent the notification by looking at it through smart glasses, see e.g. FIG. 6. The figure shows a pedestrian 600 at a street corner of an intersection between two roads 601a and 601b in an urban environment. Three vehicles 604, 606 and 608 are on road 601a, and a vehicle 610 is on road 601b. The smart glasses show the environment in a view 602. If the pedestrian looks at a vehicle that sent a notification, then an icon is placed on the vehicle displayed on the smart glasses. For example, vehicle 606 notifies pedestrian 600 that it will yield to the pedestrian, while vehicle 604 marked by “Notifying”, notifies the pedestrian with a warning “WATCH OUT” about, for example, vehicle 610 approaching from his right. Other markings may be used alternatively to mark the vehicle that sent the notification. If the vehicle yielded, the marking may change accordingly.

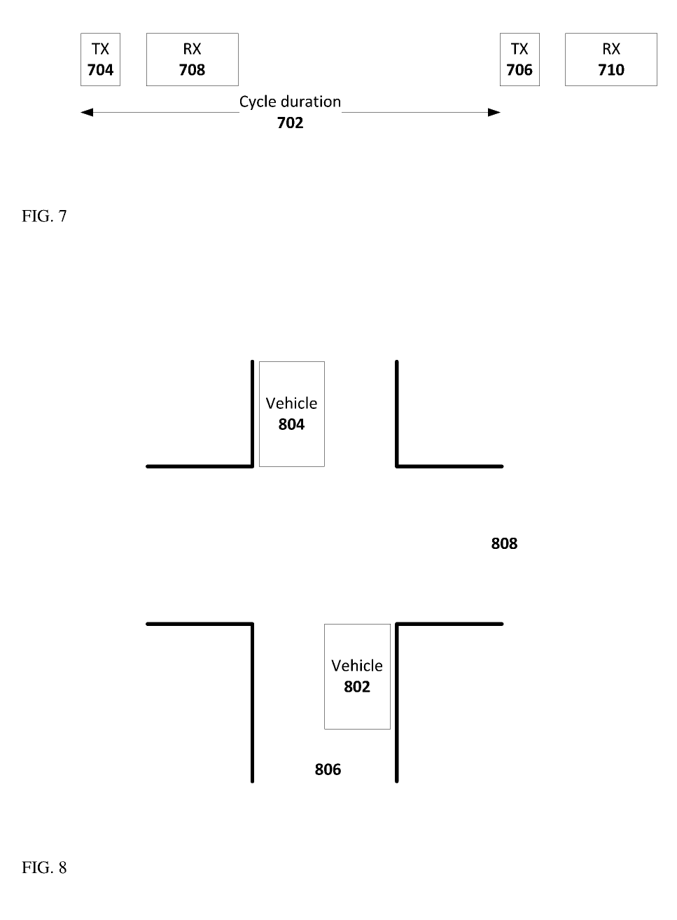

The pedestrian PU is likely to be battery operated. It is important to minimize the activity as much as possible. Transmit (TX) activity is power hungry, but power consumed by receive (RX) activity is also considerable. It is desired to limit the receive activity to minimum. A low power operation concept is illustrated in FIG. 7. The pedestrian only broadcasts a periodic safety message once every cycle duration 702. In this figure, two messages 704 and 706 were transmitted in two separate cycles. The cycle duration for vehicle transmissions is 100 ms. The cycle duration for pedestrian transmissions will probably be 1 s. A PU may periodically probe other (pedestrian or vehicular) units to understand if activity can be reduced (see U.S. Pat. No. 8,738,280). During other periods, the pedestrian unit may ignore all vehicle messages (including the periodic safety messages) and relate only to messages directly related to it (i.e. the notification messages described above). The assumption is that a vehicle has ability to avoid an accident with a pedestrian, but the pedestrian does not have the ability to avoid an accident with the vehicle. Therefore, it would not make much sense for the pedestrian to calculate a collision probability based on receive (RX) messages. Furthermore, the pedestrian location is probably not sufficiently accurate for the pedestrian to make an informed decision on a potential danger. The pedestrian only relates to messages directly addressed to him/her, which can be received in a pre-defined window, e.g. windows 708 and 710 in FIG. 7. The RX window starts X msec after transmission ends, where X is typically 0-20 msec, and lasts for Y msec, where Y is typically 10-msec.

As stated, a human has no ability to understand an autonomous vehicle. The exact same notification message can be used to inform the driver of a vehicle about the intention of an autonomous vehicle. For example, FIG. 8 shows a 4-way stop with two vehicles 802 and 804 on a road 806 that may have arrived simultaneously at an intersection with a road 808. Vehicle 802 is autonomous while vehicle 804 may be autonomous or driven by a driver. The dedicated notification message of FIG. 4 can be sent by autonomous vehicle 802 to the driver of vehicle 804 to indicate that it was noticed. The dedicated notification message may also indicate whether vehicle 802 yields or takes the right-of-way (when not yielding). The message is displayed in a vehicle 804 display (not shown), for example, in a heads-up display if vehicle 804 is not autonomous. It should be noted that although this message is not used for negotiating right-of-way, it can be used in a similar way to that of negotiation between human drivers. If the right-of-way is not taken by vehicle 802, then vehicle 804, if autonomous, may decide to take it and can update accordingly its notification message. In general, dedicated notification messages disclosed herein may be sent by autonomous vehicles, and may be received by either humans or other autonomous vehicles.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

For example, any digital computer system can be configured or otherwise programmed to implement a method disclosed herein, and to the extent that a particular digital computer system is configured to implement such a method, it is within the scope and spirit of the disclosure. Once a digital computer system is programmed to perform particular functions pursuant to computer-executable instructions from program software that implements a method disclosed herein, it in effect becomes a special purpose computer particular to an embodiment of the method disclosed herein. The techniques necessary to achieve this are well known to those skilled in the art and thus are not further described herein. The methods and/or processes disclosed herein may be implemented as a computer program product such as, for example, a computer program tangibly embodied in an information carrier, for example, in a non-transitory computer-readable or non-transitory machine-readable storage device and/or in a propagated signal, for execution by or to control the operation of, a data processing apparatus including, for example, one or more programmable processors and/or one or more computers. The term “non-transitory” is used to exclude transitory, propagating signals, but to otherwise include any volatile or non-volatile computer memory technology suitable to the application including, for example, distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by a communication network.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

It is appreciated that certain features disclosed herein, which are, for clarity, described in the context of separate embodiments or examples, may also be provided in combination in a single embodiment. Conversely, various features disclosed herein, which are, for brevity, described in the context of a single embodiment, may also be provided separately or in any suitable sub-combination or as suitable in any other described embodiment disclosed herein. Certain features described in the context of various embodiments are not to be considered essential features of those embodiments, unless the embodiment is inoperative without those elements.

What is claimed is:

1. A method for wireless communication in an environment that includes autonomous vehicles, comprising: by a given autonomous vehicle, transmitting a dedicated notification message to a personal unit of a particular pedestrian, wherein the personal unit is configured to alert the particular pedestrian about contents of the dedicated notification message.

2. The method of claim 1, wherein the personal unit is configured to alert the particular pedestrian by displaying at least part of the dedicated notification message on a human-machine interface of the personal unit.

3. The method of claim 2, wherein the human-machine interface includes a radar-like display of a smartphone.

4. The method of claim 1, wherein the personal unit includes a personal electronic device.

5. The method of claim 1, wherein the personal unit includes an augmented reality device.

6. The method of claim 5, wherein the augmented reality device includes smart glasses.

7. The method of claim 1, wherein the transmitting a dedicated notification message to a personal unit of a particular pedestrian includes transmitting a notification device having at least one attribute.

8. The method of claim 7, wherein the at least one attribute includes an attribute by which the autonomous vehicle indicates an action intended by the autonomous vehicle.

9. The method of claim 8, wherein the intended action includes an action to yield to the particular pedestrian.

10. The method of claim 7, wherein the at least one attribute includes an attribute by which the autonomous vehicle indicates its relative positioning to the particular pedestrian.

11. The method of claim 7, wherein the at least one attribute includes an attribute by which the autonomous vehicle warns the particular pedestrian about other vehicles.

12. The method of claim 1, wherein the personal unit is further configured to have an open receive window for receiving the dedicated notification message in a fixed time slot for power saving.

13. A method for wireless communication in an environment that includes autonomous vehicles, comprising: by a given autonomous vehicle, broadcasting a periodic notification message having at least one dedicated attribute addressed to a personal unit of a particular pedestrian or of a particular driver of a manned vehicle, wherein the personal unit is configured to alert the particular pedestrian or particular driver about the at least one dedicated attribute.

14. The method of claim 13, wherein the personal unit is configured to alert the particular pedestrian or particular driver by displaying the at least one of the dedicated attribute on a human-machine interface of the personal unit.

15. The method of claim 13, wherein the personal unit includes a personal electronic device.

16. The method of claim 13, wherein the personal unit includes an augmented reality device.

17. The method of claim 16, wherein the augmented reality device includes smart glasses.

18. The method of claim 13 wherein the at least one dedicated attribute includes an attribute by which the autonomous vehicle indicates an action intended by the autonomous vehicle.

19. The method of claim 18, wherein the action intended includes an action to yield to the particular pedestrian or particular driver.

20. The method of claim 13, wherein the at least one dedicated attribute includes an attribute by which the autonomous vehicle indicates its relative positioning to the particular pedestrian or particular driver.
